(19) United States
(12) Patent Application Publication
(10) Pub. No.: US 2015/0212381 A1
(43) Pub. Date: Jul. 30, 2015

(54) LIQUID CRYSTAL DISPLAY

(71) Applicant: AU Optronics Corp., Hsin-Chu (TW)

(72) Inventor: Ming-Hung Wu, Hsin-Chu (TW)

(21) Appl. No.: 14/559,935

(22) Filed: Dec. 4, 2014

(30) Foreign Application Priority Data
Jan. 28, 2014 (TW) 103103244

(51) Int. Cl. G02F 1/1362; G02F 1/1343; G02F 1/1368

(52) U.S. Cl. CPC G02F 1/136286; G02F 1/1368; G02F 1/134336

(57) ABSTRACT

A liquid crystal display (LCD) has a pixel matrix, a plurality of shift registers, a plurality of common voltage generators, a plurality of common voltage buffers, and a plurality of primary bidirectional switch circuits. The shift registers sequentially output gate signals to scan lines of the pixel matrix. The common voltage generators output initial common voltages according to the gate signals. The common voltage buffers are configured to buffer the initial common voltages to output a plurality of common voltages to a plurality of common voltage lines of the pixel matrix. Each of the primary bidirectional switch circuits is configured to control electrical connection between two of the common voltage lines according to one or more gate signals outputted from at least one of the shift registers.

### BACKGROUND OF THE INVENTION

1. Field of the Invention

The present invention is related to a liquid crystal display, and more particularly to a liquid crystal display capable of sharing electric charge of common voltage lines thereof.

2. Description of the Prior Art

Liquid crystal displays (LCDs) are the most popular displays nowadays. Due to the properties of lightweight, low energy consumption, and free of radiation emission, LCDs have gradually replaced the cathode ray tube (CRT) monitors of conventional personal computers and have been widely-used in many portable information products, such as notebooks, personal digital assistants (PDAs), etc.

Due to the vigorous development of smart phones, customer demand for small-sized display panels with a narrow bezel and high resolution design is increasing. However, high resolution results in a greater load of the common voltage circuits of the display panel, such that it is required to increase the size of common voltage buffers of the display panel to improve the current driving capability thereof for feeding a greater load. Since large-sized common voltage buffers require a greater layout area, it is difficult to achieve a narrow bezel design of the display panel.

### SUMMARY OF THE INVENTION

An embodiment of the present invention provides a liquid crystal display (LCD). The LCD comprises a pixel matrix, a plurality of shift registers, a plurality of common voltage generators and a plurality of primary bidirectional switch circuits. The pixel matrix comprises a plurality of pixels, a plurality of scan lines and a plurality of common voltage lines. The pixels are arranged in a plurality of rows. Each of the scan lines is coupled to pixels arranged in one of the rows. Each of the common voltage lines is coupled to the pixels arranged in one of the rows. The shift registers are coupled to the scan lines and configured to sequentially output gate signals to the scan lines. The common voltage generators are coupled between the shift registers and the common voltage lines and configured to output initial common voltages according to the gate signals. The primary bidirectional switch circuits are coupled to the shift registers and the common voltage lines. Each of the primary bidirectional switch circuits is configured to control electrical connection between two of the common voltage lines according to at least one of the gate signals output from the shift registers.

According to the embodiments of the present invention, with the help of primary bidirectional switch circuits, the LCD may control electrical connections of the common voltage lines according to timing of polarity inversion of each row of pixel. Accordingly, electric charge of each common voltage line may be shared to other common voltage lines, and an equivalent capacitance of pixels driven by the common voltage buffers may be not too great. Since the equivalent capacitance of pixels driven by the common voltage buffers may be not too great, the layout area of the common voltage buffers may be reduced to contribute to the achievement of a narrow bezel design of the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a liquid crystal display according to an embodiment of the present invention.

FIG. 2 is a schematic diagram of a pixel matrix in FIG. 1.

FIG. 3 is a circuit diagram of a pixel in FIG. 2.

FIG. 4 is a schematic diagram of the pixel matrix and a gate driver in FIG. 1.

FIG. 5 is a timing diagram of the liquid crystal display in FIG. 1.

FIG. 6 is a circuit diagram of a primary bidirectional switch circuit in FIG. 4.

FIG. 7 is a timing diagram of the primary bidirectional switch circuit in FIG. 6.

FIG. 8 is a circuit diagram of a common voltage generator in FIG. 4.

FIG. 9 is a circuit diagram of an inverting circuit in FIG. 8.

FIG. 10 is a schematic diagram of a liquid crystal display according to another embodiment of the present invention.

FIG. 11 is a schematic diagram of a pixel matrix and a first gate driver in FIG. 10.

FIG. 12 is a schematic diagram of the pixel matrix and a second gate driver in FIG. 10.

FIG. 13 is a schematic diagram of a liquid crystal display having a first gate driver and a second gate driver of the present invention.

FIGS. 14 and 15 are schematic diagrams of the pixel matrix, the first gate driver and the second gate driver in FIG. 13 according to another embodiment of the present invention.

FIGS. 16 and 17 are schematic diagrams of the pixel matrix, the first gate driver and the second gate driver in FIG. 13 according to another embodiment of the present invention.

FIG. 18 is a circuit diagram of a primary bidirectional switch circuit in FIGS. 16 and 17.

FIG. 19 is a timing diagram of the primary bidirectional switch in FIG. 18.

FIGS. 20 and 21 are schematic diagrams of the pixel matrix, the first gate driver and the second gate driver in FIG. 13 according to another embodiment of the present invention.

FIG. 22 is a circuit diagram of a secondary bidirectional switch circuit in FIGS. 20 and 21.

### DETAILED DESCRIPTION

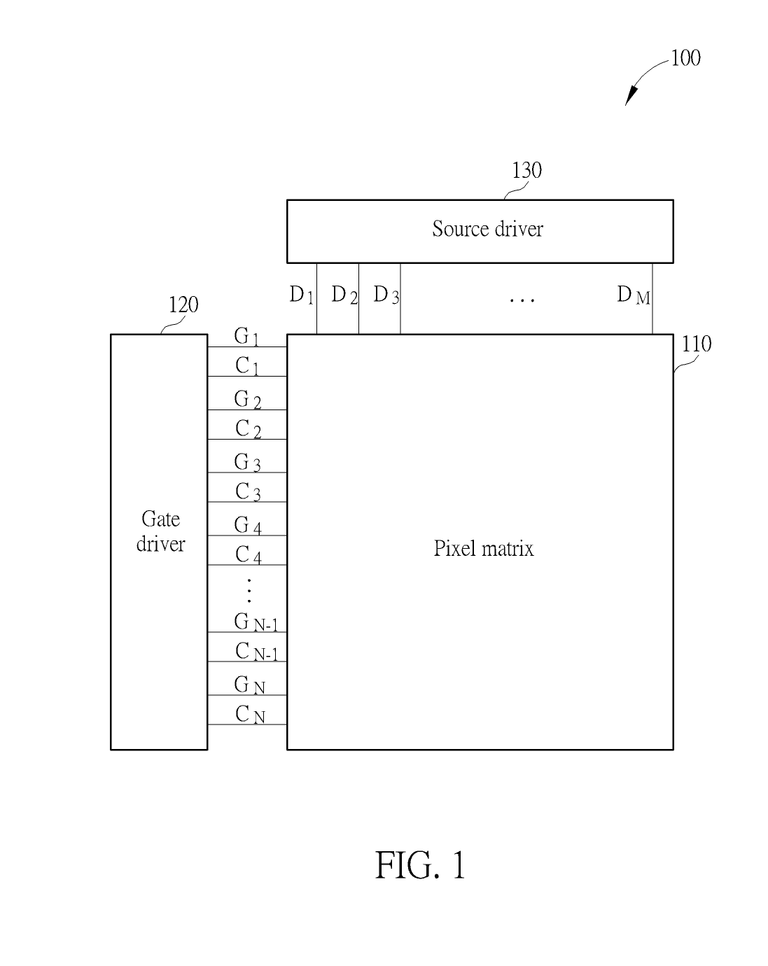

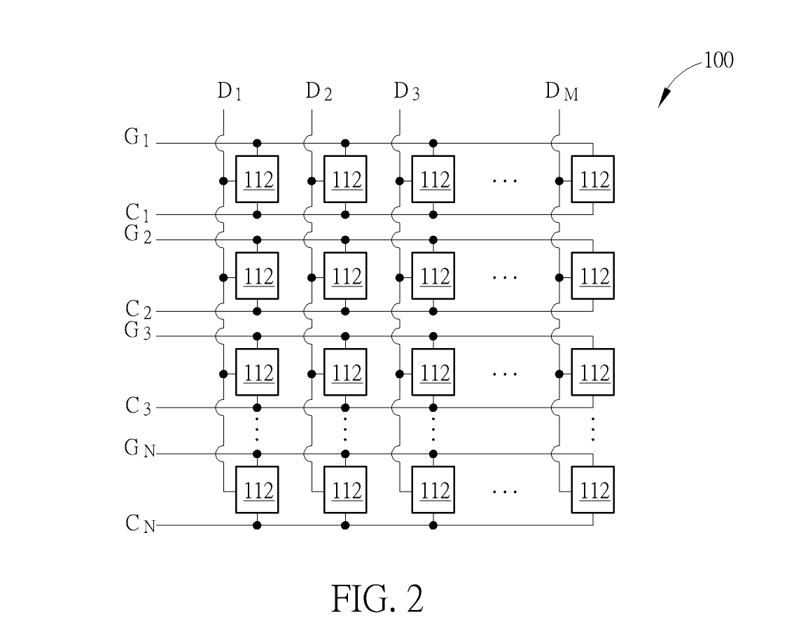

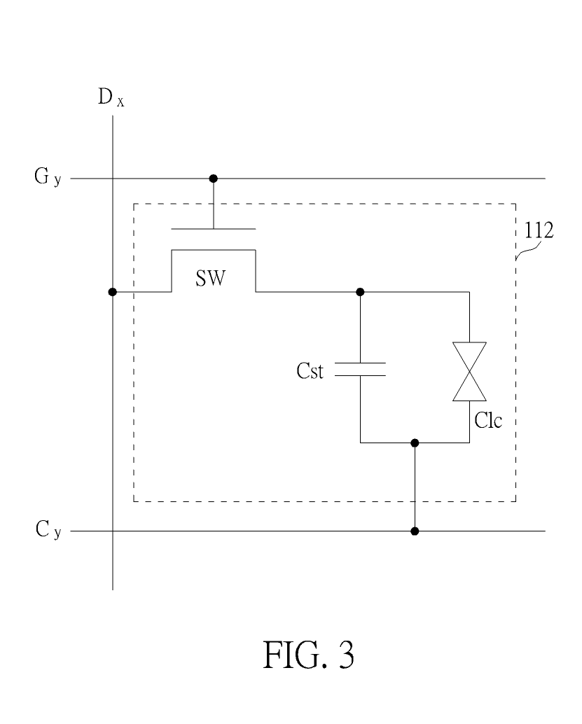

Please refer to FIGS. 1 to 3. FIG. 1 is a schematic diagram of a liquid crystal display 100 according to an embodiment of the present invention. FIG. 2 is a schematic diagram of a pixel matrix 110 in FIG. 1. FIG. 3 is a circuit diagram of a pixel 112 in FIG. 2. The liquid crystal display 100 comprises the pixel matrix 110, a gate driver 120 and a source driver 130. The pixel matrix 110 comprises a plurality of pixels 112, a plurality of scan lines G₁ to G_{N}, a plurality of common voltage lines C₁ to C_{N} and a plurality of data lines D₁ and D_{M}. The pixels 112 are arranged in N rows and M columns, where M and N are positive integers. Each of the scan lines G₁ to G_{N} is coupled to the pixels 112 arranged in one of the rows, and each of the common voltage lines C₁ to C_{N} is coupled to the pixels 112 arranged in one of the rows. Each of the pixels 112 has a switch SW, a storage capacitor Cst and a liquid crystal capacitor Clc. The switch SW may be a thin film transistor (TFT). Each of the pixels 112 is coupled to a data line Dₓ, a scan line G_{y} and a common voltage line C_{y}, where x and y are positive integers, 1≦x≦M, and 1≦y≦N. The switch SW is turned on/off based on a voltage level of the scan line G_{y}. When the switch SW is turned on, the data line Dₓ charges the storage capacitor Cst and the liquid crystal capacitor Clc of the pixel 112 through the switch SW. A voltage level of the common voltage line C_{y} is switched once between a high voltage level and a low voltage level within a frame period. It should be noted that the circuit structure of the pixel 112 in FIG. 3 is merely an example used in the present invention, and the present invention is not limited thereto. In other words, the pixel 112 may have different circuit structures in other embodiments of the present invention.

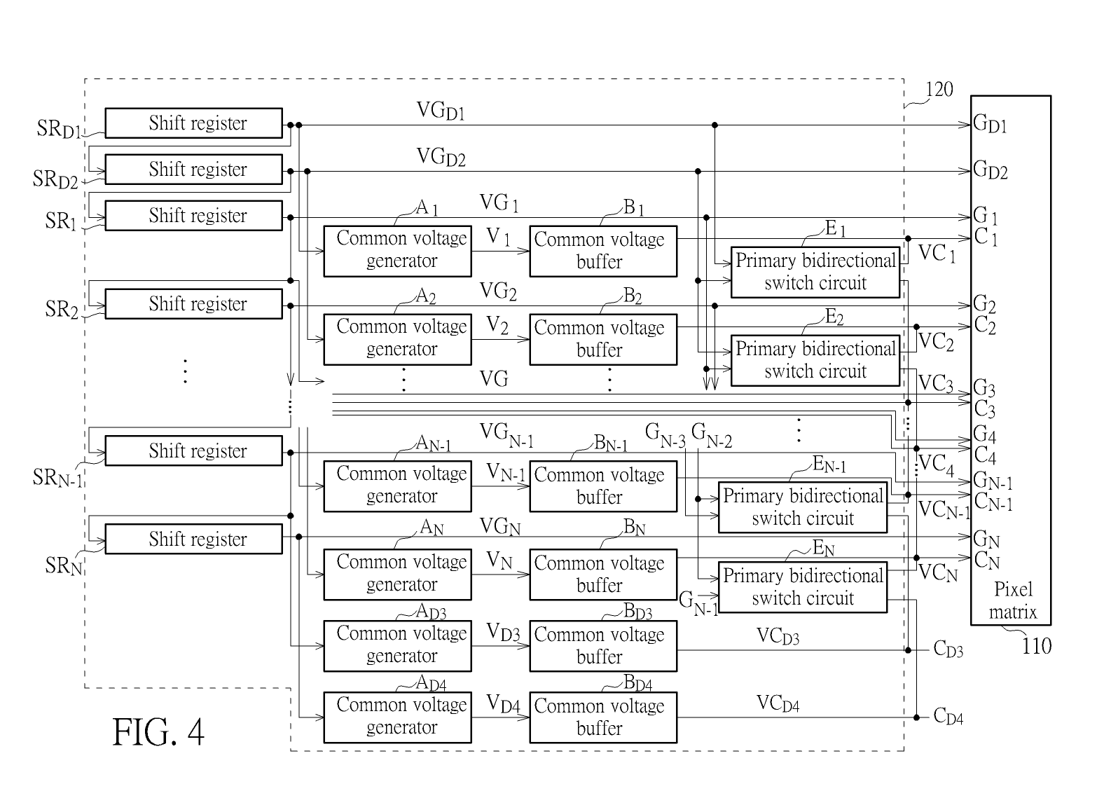

Please refer to FIG. 4. FIG. 4 is a schematic diagram of the pixel matrix 110 and the gate driver 120 in FIG. 1. The gate driver 120 has a plurality of shift registers SR_{D1}, SR_{D2} and SR₁ to SR_{N}, a plurality of common voltage generators Aₗ to A_{N}, A_{D3} and A_{D4} and a plurality of primary bidirectional switch circuits E₁ to E_{N}. The shift registers SR_{D1}, SR_{D2} and SR_{I} to SR_{N} are coupled to the scan lines G_{D1}, G_{D2} and G₁ to G_{N} and are configured to sequentially output gate signals VG_{D1}, VG_{D2} and VG₁ to VG_{N} to the scan lines G_{D1}, G_{D2} and G₁ to G_{N}. The first one shift register SR_{D1} and the second one shift register SR_{D2} are dummy shift registers, and the scan lines G_{D1} and G_{D2} are dummy scan lines and not directly coupled to any of the pixels 112. The common voltage generators A₁ to A_{N}, A_{D3} and A_{D4} are coupled between the shift registers SR_{D1}, SR_{D2} and SR₁ to SR_{N} and the common voltage lines C₁ to C_{N}, C_{D3} and C_{D4}. The common voltage generators A₁ to A_{N}, A_{D3} and A_{D4} are configured to output initial common voltages V₁ to V_{N}, V_{D3} and V_{D4} according to the gate signals VG_{D1}, VG_{D2} and VG₁ to VG_{N}. The primary bidirectional switch circuits E₁ to E_{N} are coupled to the shift registers SR_{D1}, SR_{D2} and SR₁ to SR_{N} and the common voltage lines C₁ to C_{N}, C_{D3} and C_{D4}. The common voltage generators A_{D3} and A_{D4} are dummy common voltage generators, and the common voltage lines C_{D3} and C_{D4} are dummy common voltage lines.

In an embodiment of the present invention, the output ends of the common voltage generators A_{D3} and A_{D4} are electrically coupled to the common voltage lines C₁ to C_{N}, C_{D3} and C_{D4} so as to directly apply the initial common voltages V₁ to V_{N}, V_{D3} and V_{D4} to the common voltage lines C₁ to C_{N}, C_{D3} and C_{D4}. In an embodiment of the present invention, the gate driver 120 further comprises a plurality of common voltage buffers B₁ to B_{N}, B_{D3} and B_{D4} coupled between the common voltage generators A₁ to A_{N}, A_{D3} and A_{D4} and the common voltage lines C₁ to C_{N}, C_{D3} and C_{D4}. The common voltage buffers B₁ to B_{N}, B_{D3} and B_{D4} are configured to buffer the initial common voltages V₁ to V_{N}, V_{D3} and V_{D4} so as to output a plurality of common voltages VC₁ to VC_{N}, VC_{D3} and VC_{D4} to the common voltage lines C₁ to C_{N}, C_{D3} and C_{D4}. The common voltage buffers B_{D3} and B_{D4} are dummy common voltage buffers.

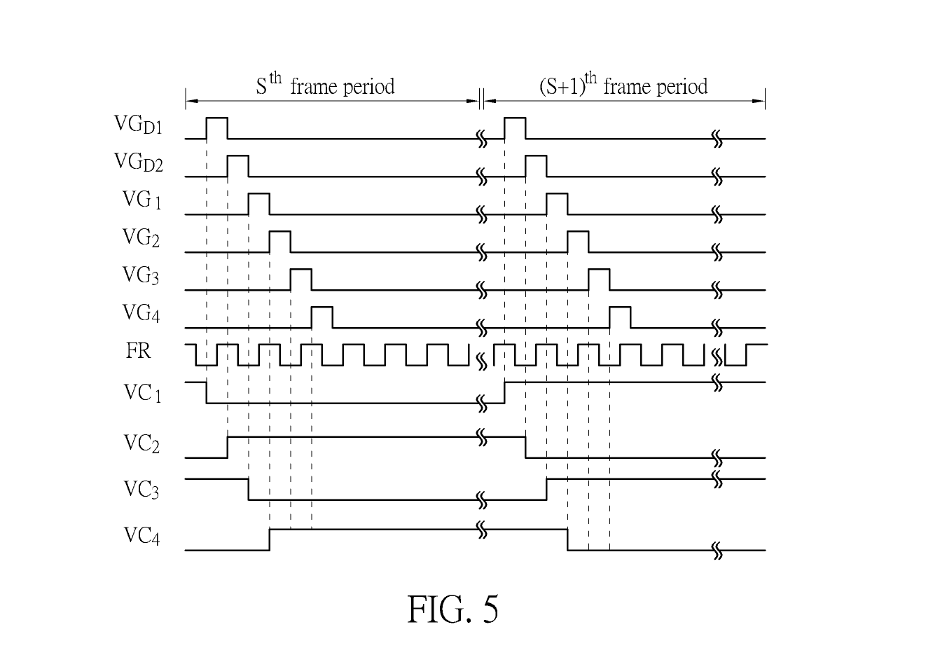

In an embodiment of the present invention, the LCD 100 changes the polarities of the pixels 112 with row inversion. Please refer FIG. 5 with reference of FIG. 4. FIG. 5 is a timing diagram of the liquid crystal display 100 in FIG. 1. Within an S^{th} frame period, odd-numbered common voltages (e.g. VC₁, VC₃, VC_{D3}) are pulled down from a high voltage level to a low voltage level, and even-numbered common voltages (e.g. VC₂, VC₄, VC_{D4}) are pulled up from the low voltage level to the high voltage level. Within an S+1^{th} frame period, odd-numbered common voltages (e.g. VC₁, VC₃, VC_{D3}) are pulled up from the low voltage level to the high voltage level, and even-numbered common voltages (e.g. VC₂, VC₄, VC_{D4}) are pulled down from the high voltage level to the low voltage level. The parameter S is a positive integer. Moreover, within each frame period of the LCD 100, the gate signals VG_{D1}, VG_{D2} and VG₁ to VG_{N} are sequentially pulled up from the low voltage level to the high voltage level. Moreover, the gate driver 120 of the LCD 100 generates the common voltages VC₁ to VC_{N}, VC_{D3} and VC_{D4} according to the voltage levels of a clock signal FR and the gate signals VG_{D1}, VG_{D2} and VG₁ to VG_{N}. The voltage level of each of the common voltages VC₁ to VC_{N} is switched two scan periods before the corresponding one of the gate signals VG_{D1} to VG_{N} is pulled up from the low voltage level to the high voltage level. For example, two scan periods before the gate signal VG₁ is pulled up from the low voltage level to the high voltage level (i.e. when the gate signal VG_{D1} is pulled up from the low voltage level to the high voltage level), the voltage level the common voltage VC₁ is switched. Two scan periods before the gate signal VG₂ is pulled up from the low voltage level to the high voltage level (i.e. when the gate signal VG_{D2} is pulled up from the low voltage level to the high voltage level), the voltage level the common voltage VC₂ is switched. Two scan periods before the gate signal VG₃ is pulled up from the low voltage level to the high voltage level (i.e. when the gate signal VG₁ is pulled up from the low voltage level to the high voltage level), the voltage level the common voltage VC₃ is switched. The rest may be deduced by analogy. Moreover, the voltage level the common voltage VC_{D3} is switched when the gate signal VG_{N-1} is pulled up from the low voltage level to the high voltage level. The voltage level the common voltage VC_{D4} is switched when the gate signal VG_{N} is pulled up from the low voltage level to the high voltage level.

Please refer to FIG. 4 again. Each of the primary bidirectional switch circuits E₁ to E_{N} is configured to control electrical connection between two of the common voltage lines C₁ to C_{N}, C_{D3} and C_{D4} according to two of the gate signals output from two of the shift registers SR_{D1}, SR_{D2} and SR₁ to SR_{N}. For example, in an embodiment of the present invention, the primary bidirectional switch circuit E₁ is configured to control electrical connection between the common voltage lines C₁ and C₂ according to the gate signals VG_{D1} and VG_{D2} output from the shift registers SR_{D1} and SR_{D2}. The primary bidirectional switch circuit E₂ is configured to control electrical connection between the common voltage lines C₂ and C₃ according to the gate signals VG_{D2} and VG₁ output from the shift registers SR_{D2} and SR₁. The primary bidirectional switch circuit E_{N-1} is configured to control electrical connection between the common voltage lines C_{N-1} and C_{D3} according to the two gate signals which two of shift registers SR_{D1}, SR_{D2}, SR₁ to SR_{N} apply to the gate lines G_{N-2} and G_{N-3}. The primary bidirectional switch circuit E_{N} is configured to control electrical connection between the common voltage lines C_{N} and C_{D4} according to the two gate signals which two of shift registers SR_{D1}, SR_{D2}, SR₁ to SR_{N} apply to the gate lines G_{N-1} and G_{N-2}. Accordingly, electric charge may be shared among the common voltage lines C₁ to C_{N}, C_{D3} and C_{D4} via the primary bidirectional switch circuits E₁ to E_{N}.

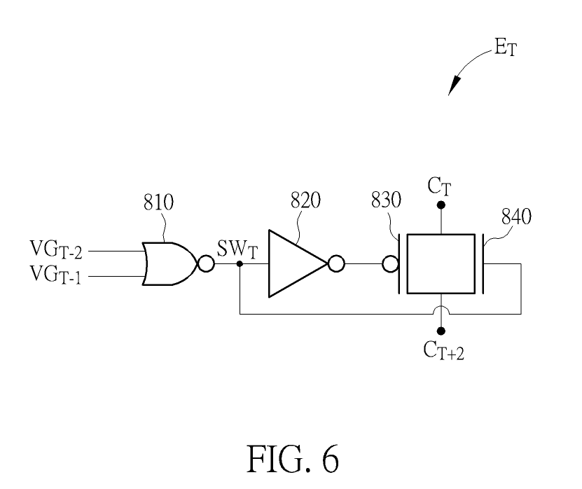

Please refer to FIG. 6 and FIG. 4. FIG. 6 is a circuit diagram of a primary bidirectional switch circuit E_{T} in FIG. 4, where T is a positive integer, and 1≦T≦N. The primary bidirectional switch circuit E_{T} comprises a NOR gate 810, an inverter 820, a first switch 830 and a second switch 840. The NOR gate 810 has two input ends for receiving the two gate signals VG_{T-2} and VG_{T-1} output from the two shift registers SR_{T-2} and SR_{T-1}. The NOR gate 810 is configured to perform a logic NOR operation on the two gate signals VG_{T-2} and VG_{T-1} so as to output a signal SW_{T}. Regarding the primary bidirectional switch circuit E₁ (i.e. T=1), the two shift registers SR_{T-2} and SR_{T-1} are SR_{D1} and SR_{D2}, and the two gate signals VG_{T-2} and VG_{T-1} received by the NOR gate 810 are VG_{D1} and VG_{D2}. Regarding the primary bidirectional switch circuit E₂ (i.e. T=2) , the two shift registers SR_{T-2} and SR_{T-1} are SR₂ and SR₁, and the two gate signals VG_{T-2} and VG_{T-1} received by the NOR gate 810 are VG_{D2} and VG₁. Moreover, an input end of the inverter 820 is coupled to the output end of the NOR gate 810. A first end of the first switch 830 is coupled to a common voltage line C_{T}, a second end of the first switch 830 is coupled to a common voltage line C_{T+2}, and a control end of the first switch 830 is coupled to the output end of the inverter 820. A first end of the second switch 840 is coupled to the first end of the first switch 830 and the common voltage line C_{T}, a second end of the second switch 840 is coupled to the second end of the first switch 830 and the common voltage line C_{T+2}, and a control end of the second switch 840 is coupled to the output end of the NOR gate 810. Therefore, when one of the gate signals VG_{T-2} and VG_{T-1} is at the high voltage level, the first switch 830 and the second switch 840 are turned off, and the common voltage lines C_{T} and C_{T+2} are electrically disconnected. When the gate signals VG_{T-2} and VG_{T-1} are at the low voltage level, the first switch 830 and the second switch 840 are turned on, and the common voltage lines C_{T} and C_{T+2} are electrically connected. In other words, the T^{th} primary bidirectional switch circuit E_{T} controls the electrical connection between the T^{th} common voltage line C_{T} and the T+2^{th} common voltage line C_{T+2} of the common voltage lines C₁ to C_{N}, C_{D3} and C_{D4} according to the two gate signals VG_{T-2} and VG_{T-1} output from the T^{th} shift register SR_{T-2} and the T+1^{th} shift register SR_{T-1} of the shift registers SR_{D1}, SR_{D2} and SR₁ to SR_{N}. Wherein, the first one of the shift registers is SR_{D1}, the second one of the shift registers is SR_{D2}, the third one of the shift registers is SR₁, the fourth one of the shift registers is SR₂, and so on. Therefore, the common voltage lines C_{T} and C_{T+2} share electric charge through the primary bidirectional switch circuit E_{T}. For example, the common voltage lines C₁ and C₃ share electric charge through the primary bidirectional switch circuit E₁. The common voltage lines C₂ and C₄ share electric charge through the primary bidirectional switch circuit E₂. Moreover, regarding the primary bidirectional switch circuit E_{N-1} (i.e. T=N−1), the two common voltage lines C_{T} and C_{T+2} are the common voltage lines C_{N-1} and C_{D3}. Regarding the primary bidirectional switch circuit E_{N} (i.e. T=N), the two common voltage lines C_{T} and C_{T+2} are the common voltage lines C_{N} and C_{D4}. Further, an equivalent capacitance of the pixels 112 driven by the common voltage lines C_{T} and C_{T+2} when the common voltage lines C_{T} and C_{T+2} are electrically connected is less than that when the common voltage lines C_{T} and C_{T+2} are electrically disconnected. The primary bidirectional switch circuit E_{T} may be any one of the primary bidirectional switch circuits E₁ to E_{N}, and the common voltage lines C₁ to C_{N} are driven by the common voltage buffers B₁ to B_{N}. Accordingly, due to the primary bidirectional switch circuits E₁ to E_{N}, an equivalent capacitance of the pixels 112 driven by the common voltage buffers B₁ to B_{N} in FIG. 4 may be not too great. Therefore, the layout area of the common voltage buffers B₁ to B_{N} may be reduced to contribute to the achievement of the narrow bezel design of the display panel.

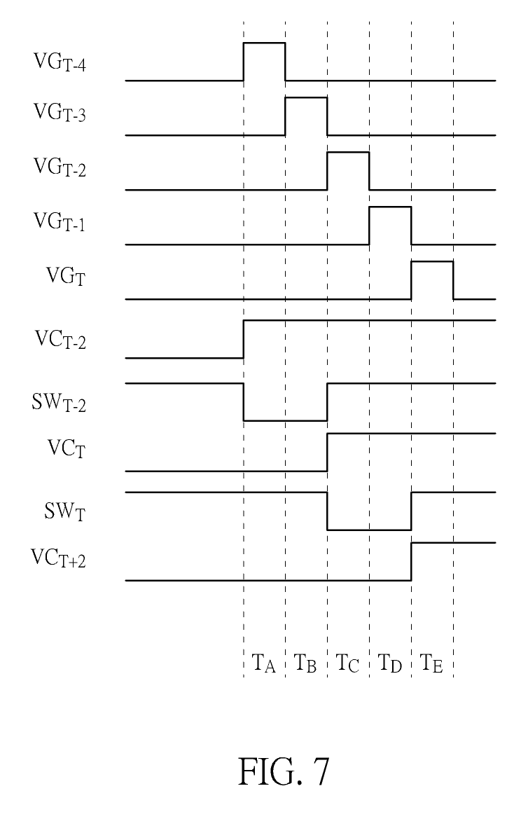

Please refer to FIG. 7 and FIG. 6. FIG. 7 is a timing diagram of the primary bidirectional switch E_{T} in FIG. 6. The voltage levels of the gate lines VG_{T-4} to VG_{T} are sequentially at the high voltage level within the durations T_{A} to T_{E}, and the common voltages VC_{T-2}, VC_{T} and VC_{T+2} are pulled up from the low voltage level to the high voltage level respectively while the gates signals VG_{T-4}, VG_{T-2} and VG_{T} are pulled up to the high voltage level. Within the durations T_{C} and T_{D}, the common voltages VC_{T} and VC_{T+2} are at different voltage levels, such that it is not proper to share electric charge between the common voltage lines C_{T} and C_{T+2} . Therefore, the primary bidirectional switch E_{T} in FIG. 6 should electrically disconnect the common voltage line C_{T} from the common voltage line C_{T+2} within the durations T_{C} and T_{D}. As shown in FIGS. 6 and 7, since the ate lines VG_{T-2} to VG_{T-1} are not both at the low voltage level within the durations T_{C} and T_{D}, the signal SW_{T} is at the low voltage level, such that the common voltage lines C_{T} and C_{T+2} are electrically disconnected within the durations T_{C} and T_{D}. Accordingly, when the common voltages VC_{T} and VC_{T+2} are at different voltage levels, the sharing of electric charge between the common voltage lines C_{T} and C_{T+2} is paused. In the same way, the signal SW_{T-2} is at the low voltage level within the durations T_{A} and T_{B}, such that the common voltage lines C_{T-2} and C_{T} are electrically disconnected within the durations T_{A} and T_{B}. Therefore, when the common voltages VC_{T-2} and VC_{T} are at different voltage levels, the sharing of electric charge between the common voltage lines C_{T-2} and C_{T} is paused.

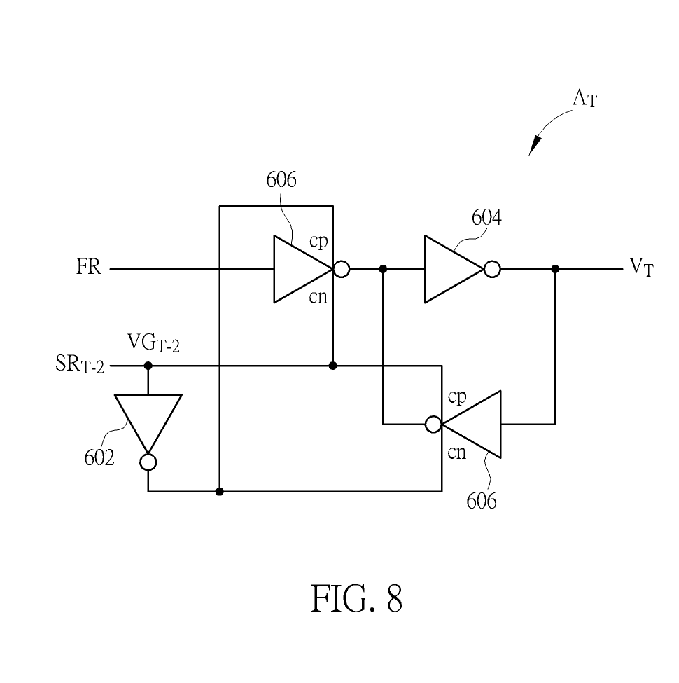

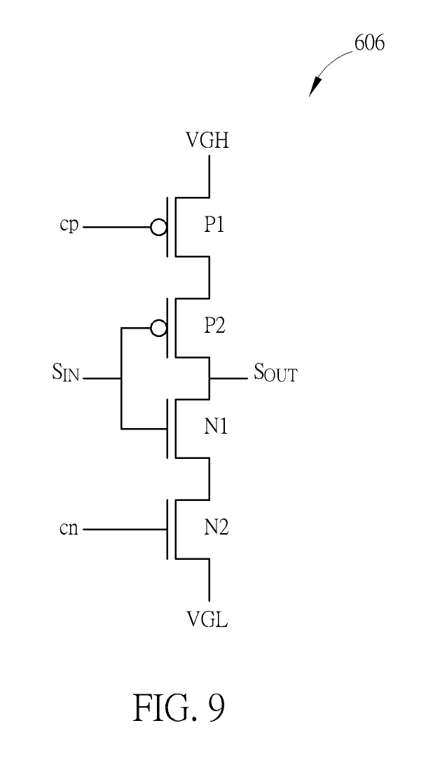

Please refer to FIGS. 8 and 9 with reference of FIG. 4. FIG. 8 is a circuit diagram of a common voltage generator A_{T} in FIG. 4, and FIG. 9 is a circuit diagram of an inverting circuit 606 in FIG. 8, where T is a positive integer, and 1≦T≦N. The common voltage generator A_{T} has two inverters 602 and 604 and two inverting circuits 606. The inverter 602 is configured to receive the gate signal VG_{T-2} output from the T^{th} shift register SR_{T-2}, and the input end of the inverter 604 is coupled to the output ends of the two inverting circuits 606. In an embodiment of the present invention, each of the inverting circuits 606 may comprise two P-type metal-oxide-semiconductor field effect transistors (PMOSFETs) P1 and P2 and two N-type metal-oxide-semiconductor field effect transistors (NMOSFETs) N1 and N2. The source of the PMOSFET P1 is coupled to a gate-high voltage level VGH, the gate of the PMOSFET P1 is coupled to a first control end cp of the inverting circuit 606, and the drain of the PMOSFET P1 is coupled to the source of the PMOS P2. The gate of the PMOSFET P2 and the gate of the NMOSFET N1 are coupled to an input end S_{IN} of the inverting circuit 606, and the drain of the PMOSFET P2 and the drain of the NMOSFET N1 are coupled to an output end S_{OUT} of the inverting circuit 606. The drain of the NMOSFET N2 is coupled to the source of the NMOSFET N1, the gate of the NMOSFET N2 is coupled to a second control end cn of the inverting circuit 606, and the source of the NMOSFET N2 is coupled to a gate-low voltage level VGL. Therefore, the common voltage generator A_{T} may latch the gate signal VG_{T-2} according to the clock signal FR so as to output the initial common voltage V_{T}.

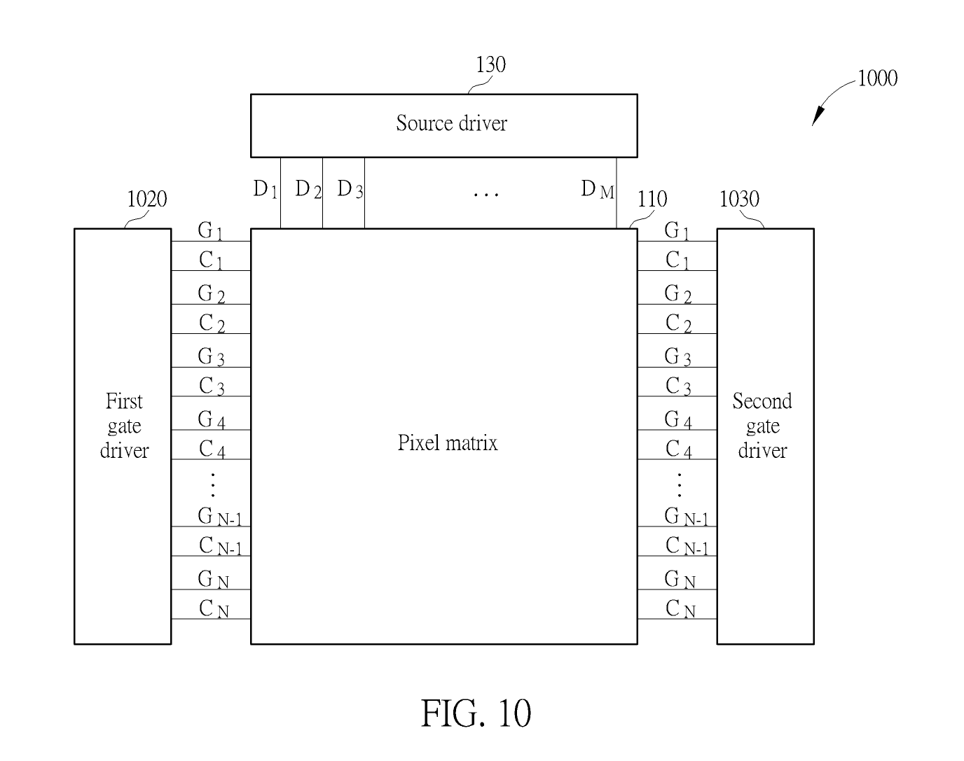

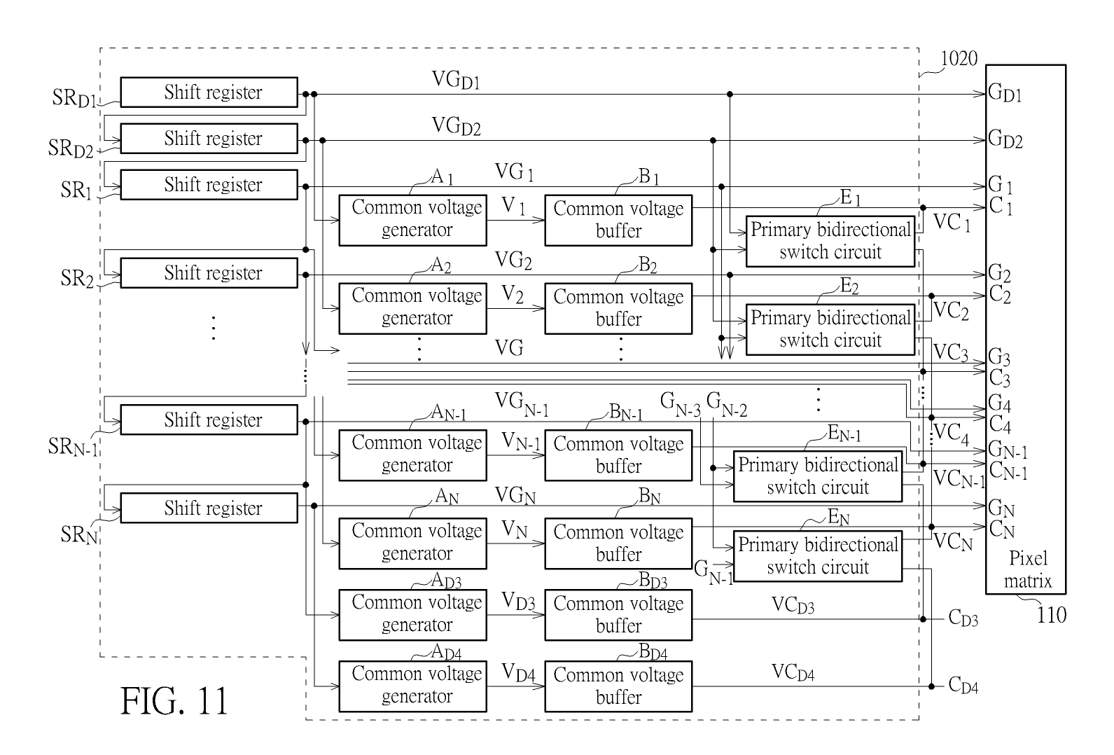

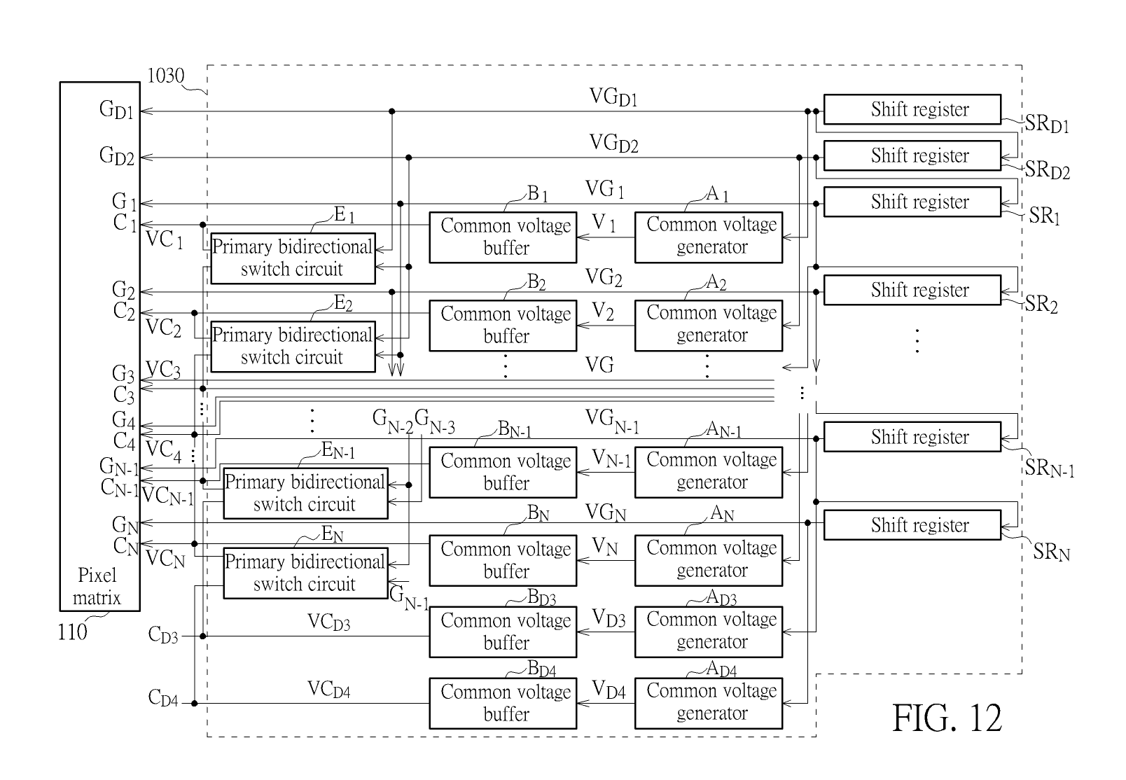

In the above embodiments, the LCD 100 uses the single gate driver 120 to perform single-sided scanning operations. However, the present invention may be also adopted in an LCD that uses two gate drivers to perform double-sided scanning operations. Please refer to FIGS. 10 to 12. FIG. 10 is a schematic diagram of a liquid crystal display 1000 according to another embodiment of the present invention. FIG. 11 is a schematic diagram of a pixel matrix 110 and a first gate driver 1020 of the LCD 1000 in FIG. 10. FIG. 12 is a schematic diagram of the pixel matrix 110 and a second gate driver 1030 of the LCD 1000 in FIG. 10. The LCD 1000 comprises the pixel matrix 110, a first gate driver 1020, a second gate driver 1030 and the source driver 130. The first gate driver 1020 and the second gate driver 1030 are positioned at two opposite sides of the LCD 1000. The functions of the pixel matrix 110 and the source driver 130 has explained in the previous descriptions, and the circuit structure of the first gate driver 1020 is completely the same as that of the gate driver 120, and will thus not be repeated herein. Moreover, the circuit structure of the second gate driver 1030 is completely symmetrical with that of the first gate driver 1020, and the components of the second gate driver 1030 has the same functions as the components of the first gate driver 1020, which are configured to generate and output the gate signals VG₁ to VG_{N} to the scan lines G₁ to G_{N} and are configured to output the common voltages VC₁ to VC_{N}, VC_{D3} and VC_{D4} to the common voltage lines C₁ to C_{N}, C_{D3} and C_{D4}. Since each of the scan lines G₁ to G_{N} receives a corresponding one of the gate signals VG₁ to VG_{N} from the first fate driver 1020 and the second gate driver 1030 positioned at the two opposite sides of the LCD 1000, and each of the common voltage lines C₁ to C_{N} receives one of the common voltages VC₁ to VC_{N} from the first fate driver 1020 and the second gate driver 1030, the image quality at the rims of the LCD 1000 is better than that of the LCD 100.

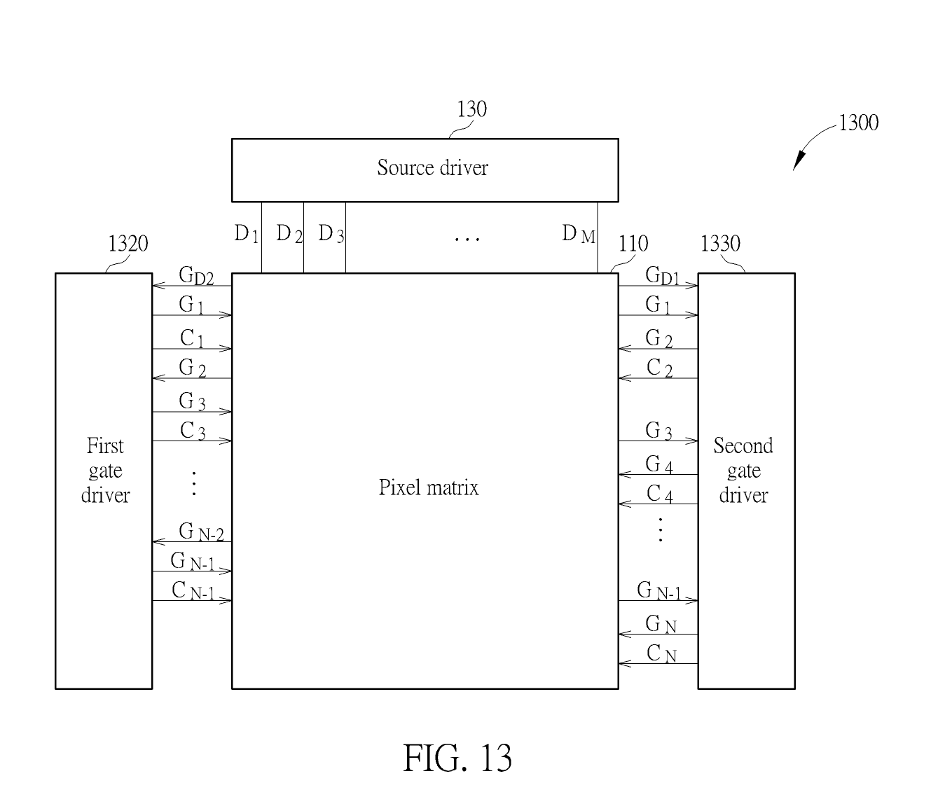

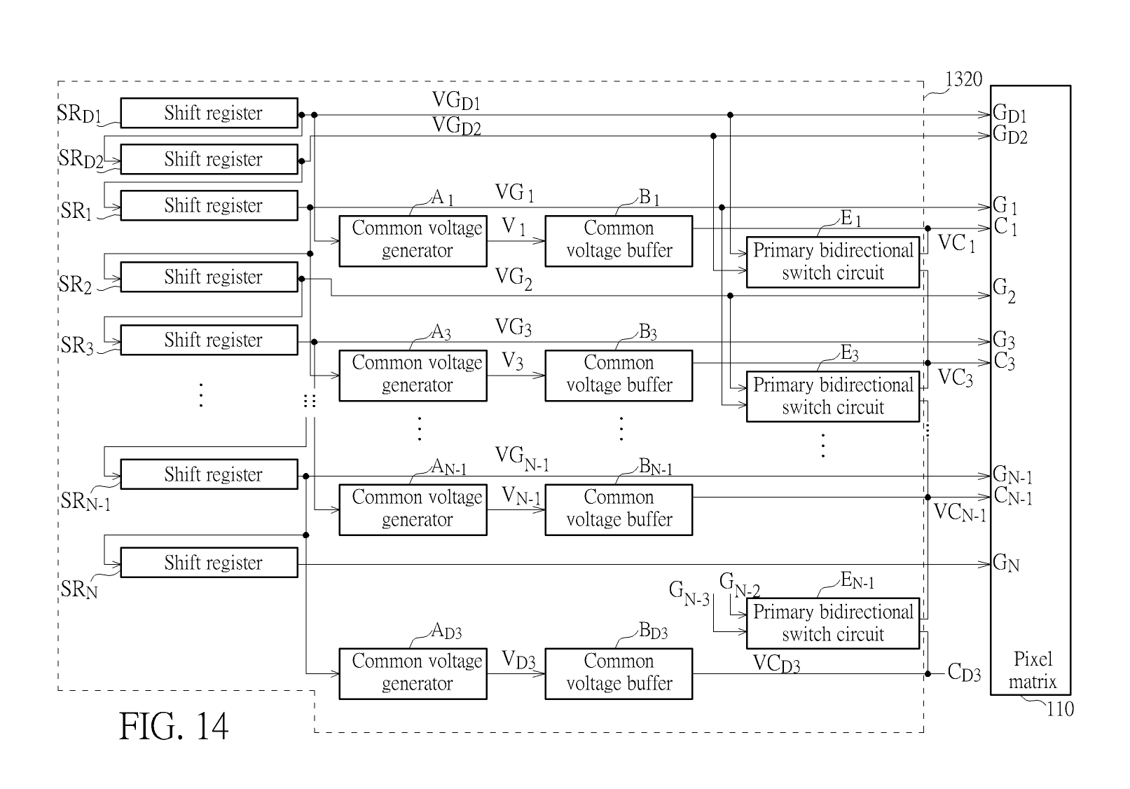

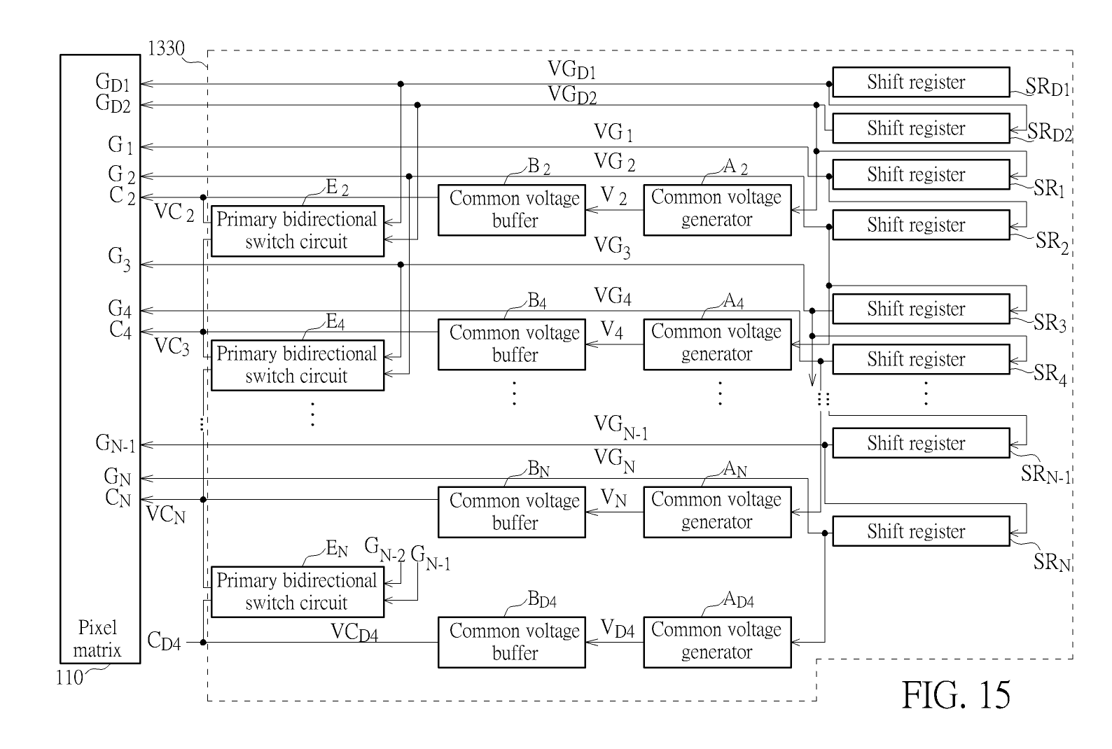

The LCD 100 uses a single gate driver to perform single-sided scanning operations, and the LCD 1000 uses two gate drivers to perform double-sided scanning operations. However, the present invention may be also adopted in an LCD that uses two gate drivers to perform single-sided scanning operations. Please refer to FIGS. 13 to 15. FIG. 13 is a schematic diagram of a liquid crystal display 1300 having a first gate driver 1320 and a second gate driver 1330 of the present invention. FIGS. 14 and 15 are schematic diagrams of the pixel matrix 110, the first gate driver 1320 and the second gate driver 1330 in FIG. 13 according to another embodiment of the present invention. The LCD 1300 comprises the pixel matrix 110, the first gate driver 1320, the second gate driver 1330 and the source driver 130. The first gate driver 1320 and the second gate driver 1330 are positioned at two opposite sides of the LCD 1300. The functions of the pixel matrix 110 and the source driver 130 have explained in the previous descriptions, and will thus not be repeated herein. In the embodiment, the common voltage generators A₁ to A_{N}, A_{D3} and A_{D4}, the common voltage buffers B₁ to B_{N}, B_{D3} and B_{D4} and the primary bidirectional switch circuits E₁ to E_{N} are divided into two parts, and each of the parts is integrated in one of the first gate driver 1320 and the second gate driver 1330 of the LCD 1300. In more detail, the odd-numbered common voltage generators A₁, A₃, . . . , A_{N-1} and A_{D3}, the odd-numbered common voltage buffers B₁, B₃, . . . , B_{N-1} and B_{D3} and the odd-numbered common primary bidirectional switch circuits E₁, E₃, . . . and E_{N-1} are integrated in the first gate driver 1320. The even-numbered common voltage generators A₂, A₄, . . . , A_{N} and A_{D4}, the even-numbered common voltage buffers B₂, B₄, . . . , B_{N} and B_{D4} and the even-numbered common primary bidirectional switch circuits E₂, E₄, . . . and E_{N} are integrated in the second gate driver 1330. Therefore, the first gate driver 1320 transmits the odd-numbered common voltages VC₁, VC₃, . . . and VC_{N-1} to the pixel matrix 110 via the odd-numbered common voltage lines C₁, C₃, . . . and C_{N-1}, and the second gate driver 1330 transmits the even-numbered common voltages VC₂, VC₄, . . . and VC_{N} to the pixel matrix 110 via the even-numbered common voltage lines C₂, C₄, . . . and C_{N}. Moreover, each of the first gate driver 1320 and the second gate driver 1330 has N+2 shift registers SR_{D1}, SR_{D2} and SR₁ to SR_{N} that are configured to sequentially output the gate signals VG_{D1}, VG_{D2} and VG₁ to VG_{N} to the scan lines G_{D1}, G_{D2} and G₁ to G_{N}. The connections of the common voltage generators A₁ to A_{N}, A_{D3} and A_{D4}, the common voltage buffers B₁ to B_{N}, B_{D3} and B_{D4}, the primary bidirectional switch circuits E₁ to E_{N}, the scan lines G_{D1}, G_{D2} and G₁ to G_{N} and the common voltage lines C₁ to C_{N}, C_{D3} and C_{D4} of the LCD 1300 are the same as those of the LCD 100, and will thus not be repeated herein.

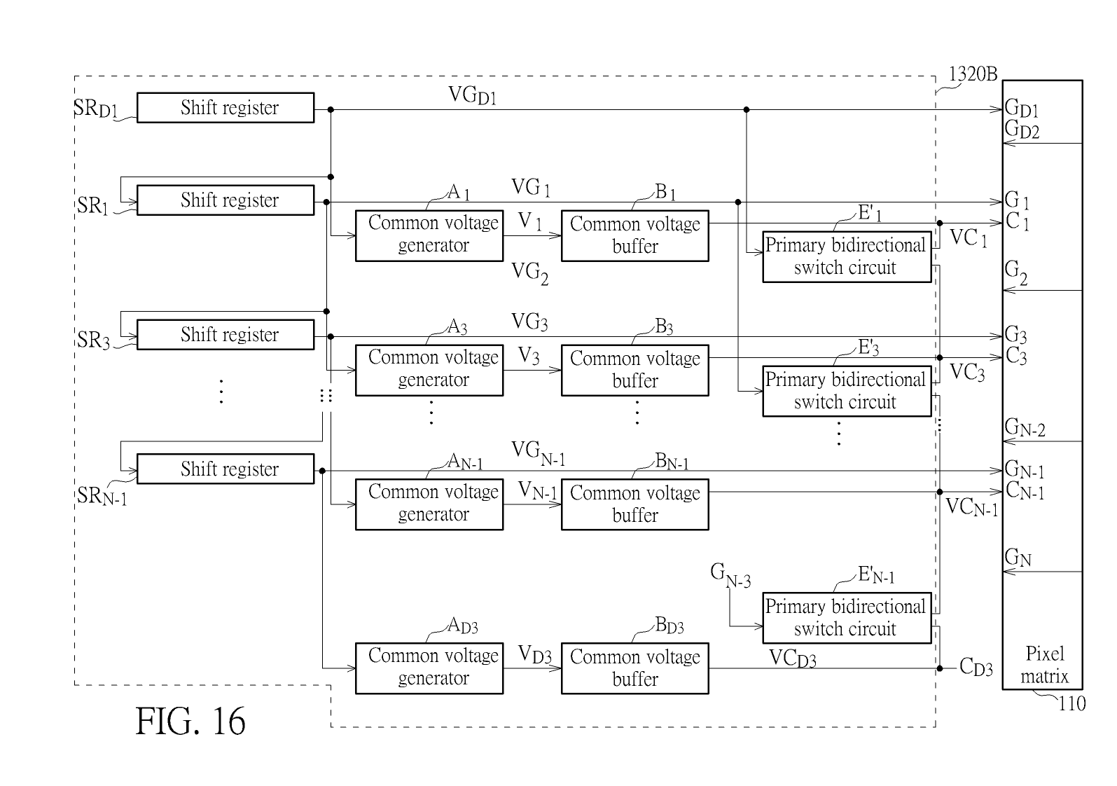

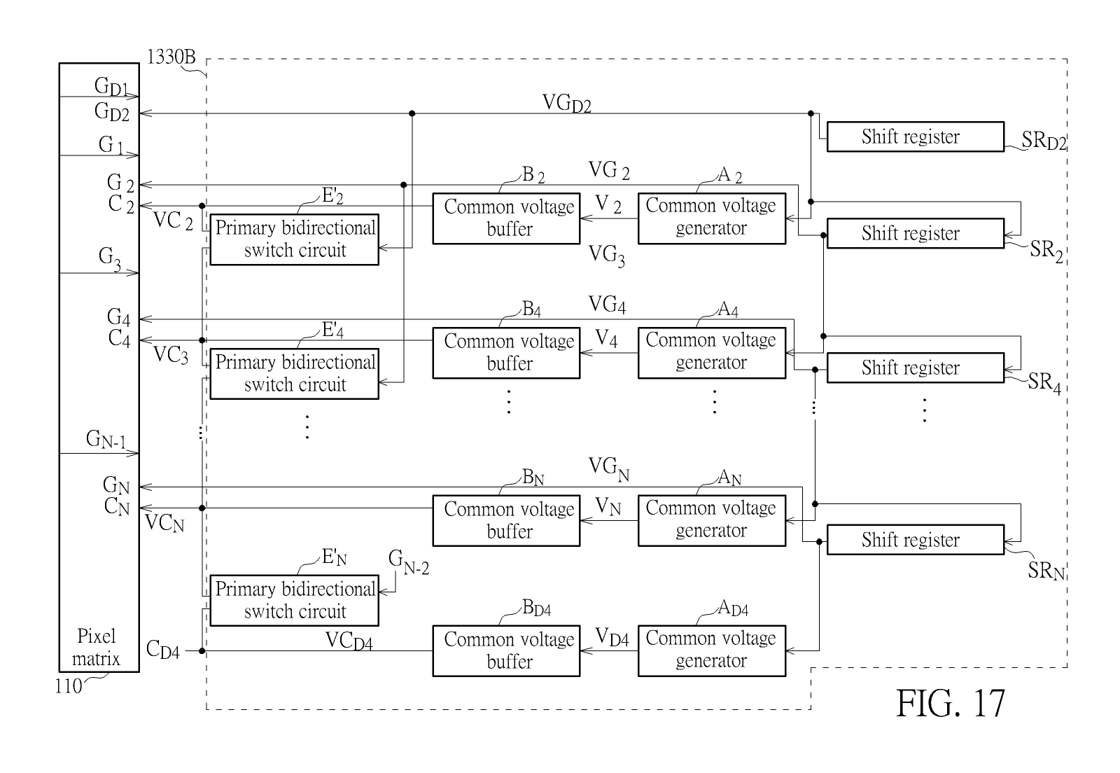

In an embodiment of the present invention, the number of shift registers of the first gate driver 1320 in FIG. 14 and the second gate driver 1330 in FIG. 15 may be reduced. For example, the first gate driver 1320 in FIG. 14 may be replaced by a first gate driver 1320B in FIG. 16, and the second gate driver 1320 in FIG. 15 may be replaced by a second gate driver 1330B in FIG. 17. Moreover, the primary bidirectional switch circuits E₁ to E_{N} may be replaced by primary bidirectional switch circuits E′₁ to E′_{N}. Please refer to FIGS. 16 and 17. In the embodiment, the common voltage generators A₁ to A_{N}, A_{D3} and A_{D4}, the common voltage buffers B₁ to B_{N}, B_{D3} and B_{D4} and the primary bidirectional switch circuits E′₁ to E′_{N} are divided into two parts, and each of the parts is integrated in one of the first gate driver 1320B and the second gate driver 1330B. In more detail, the odd-numbered common voltage generators A₁, A₃, . . . , A_{N-1} and A_{D3}, the odd-numbered common voltage buffers B₁, B₃, . . . , B_{N-1} and B_{D3} and the odd-numbered common primary bidirectional switch circuits E′₁, E′₃, . . . and E^{′}_{N-1} are integrated in the first gate driver 1320B. The even-numbered common voltage generators A₂, A₄, . . . , A_{N} and A_{D4}, the even-numbered common voltage buffers B₂, B₄, . . . , B_{N} and B_{D4} and the even-numbered common primary bidirectional switch circuits E′₂, E′₄, . . . and E′_{N} are integrated in the second gate driver 1330B.

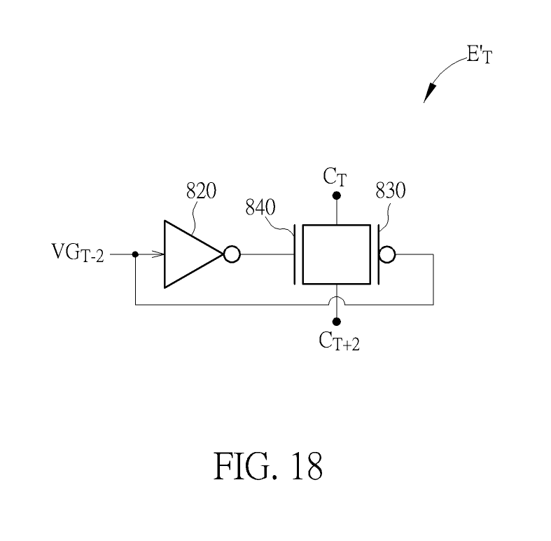

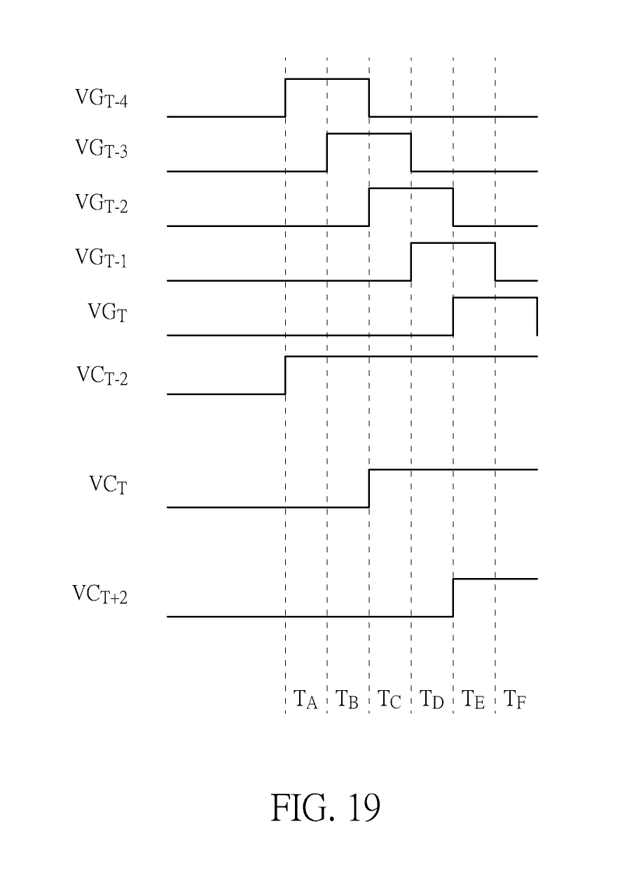

Please refer to FIGS. 18 and 19 with reference of FIGS. 16 and 17. FIG. 18 is a circuit diagram of a primary bidirectional switch circuit E′_{T} in FIGS. 16 and 17. T is a positive integer, and 1≦T≦N. FIG. 19 is a timing diagram of the primary bidirectional switch E′_{T} in FIG. 18. The gate signal VG_{T-4} is at the high voltage level within the durations T_{A} and T_{B}, the gate signal VG_{T-3} is at the high voltage level within the durations T_{B} and T_{C}, the gate signal VG_{T-2} is at the high voltage level within the durations T_{C} and T_{D}, the gate signal VG_{T-1} is at the high voltage level within the durations T_{D} and T_{E}, and the gate signal VG_{T} is at the high voltage level within the durations T_{E} and T_{F}. The primary bidirectional switch circuit E′_{T} comprises an inverter 820, a first switch 830 and a second switch 840. The input end of the inverter 820 receives the gate signal VG_{T-2}. A first end of the first switch 830 is coupled to the common voltage line C_{T}, a second end of the first switch 830 is coupled to the common voltage line C_{T+2}, and a control end of the first switch 830 receives the gate signal VG_{T-2}. A first end of the second switch 840 is coupled to the first end of the first switch 830 and the common voltage line C_{T}, a second end of the second switch 840 is coupled to the second end of the first switch 830 and the common voltage line C_{T+2}, and a control end of the second switch 840 is coupled to an output end of the inverter 820. Therefore, when the gate signal VG_{T-2} is at the high voltage level, the first switch 830 and the second switch 840 are turned off, and the common voltage line C_{T} is electrically disconnected from the common voltage line C_{T+2}. When the gate signal VG_{T-2} is at the low voltage level, the first switch 830 and the second switch 840 are turned on, and the common voltage line C_{T} is electrically connected to the common voltage line C_{T+2}. In other words, the T^{th} primary bidirectional switch circuit E′_{T} controls the electrical connection between the T^{th} common voltage line C_{T} and the T+2^{th} common voltage line C_{T+2} of the common voltage lines C₁ to C_{N}, C_{D3} and C_{D4} according to the gate signal VG_{T-2} output from the T^{th} shift register SR_{T-2} of the shift registers SR_{D1}, SR_{D2} and SR₁ to SR_{N}. Therefore, the common voltage lines C_{T} and C_{T+2} share electric charge through the primary bidirectional switch circuit E′_{T}.

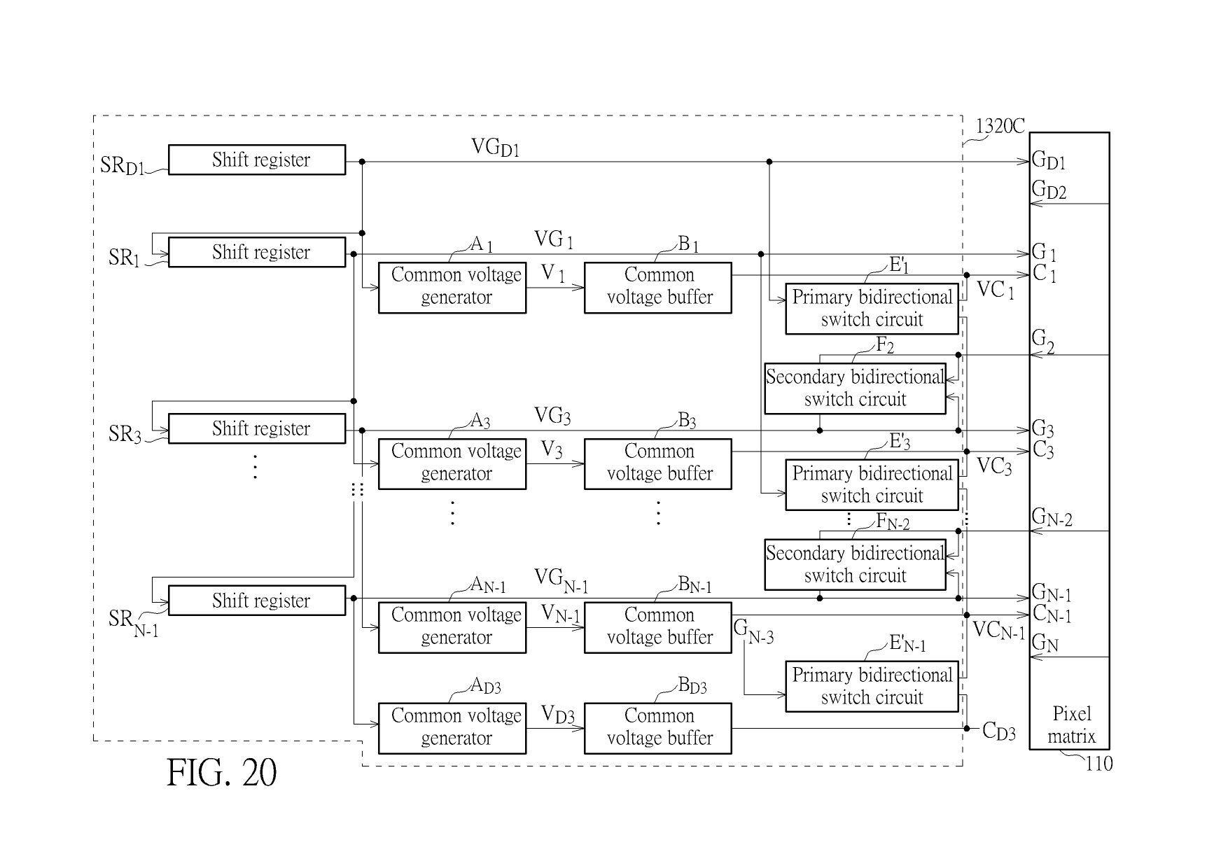

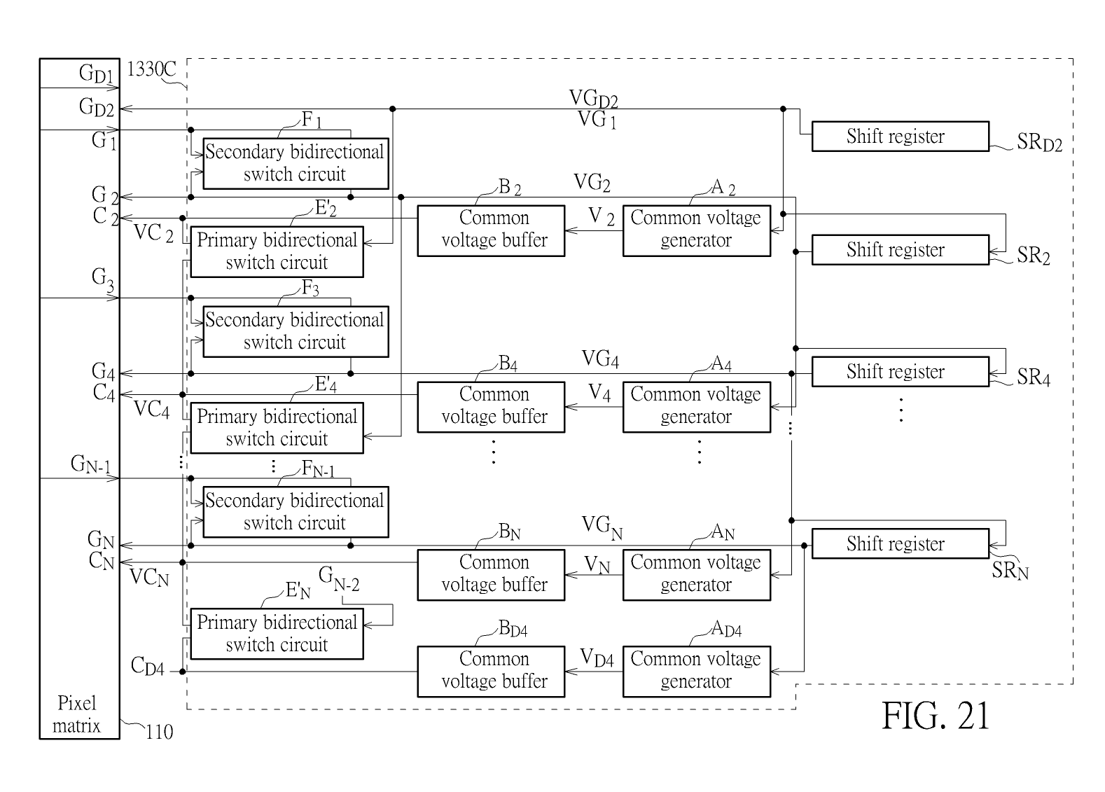

In an embodiment of the present invention, the first gate driver 1320B may be replaced by a first gate driver 1320C in FIG. 20, and the second gate driver 1320B may be replaced by a second gate driver 1330C in FIG. 21. As compared to the first gate driver 1320B and the second gate driver 1320B, the first gate driver 1320C and the second gate driver 1320C further comprise a plurality of secondary bidirectional switch circuits F₁ to F_{N-1}.

The even-numbered secondary bidirectional switch circuits F₂, F₄, . . . and F_{N-2} of the secondary bidirectional switch circuits F₁ to F_{N-1} are integrated in the first gate driver 1320C, the odd-numbered secondary bidirectional switch circuits F₁, F₃, . . . and F_{N-1} of the secondary bidirectional switch circuits F₁ to F_{N-1} are integrated in the second gate driver 1330C. The first gate driver 1320C and the second gate driver 1330C are positioned at two opposite sides of the liquid crystal display. The secondary bidirectional switch circuits F₁ to F_{N-1} are coupled to the scan lines G₁ to G_{N}. Each of the secondary bidirectional switch circuits F₁ to F_{N-1} controls the electric connection between two of the scan lines G₁ to G_{N} according to two of the gate signals VG₁ to VG_{N}. For example, the secondary bidirectional switch circuits F₁ controls the electric connection between the scan lines G₁ and G₂ according to the gate signals VG₁ and VG₂; the secondary bidirectional switch circuits F₂ controls the electric connection between the scan lines G₂ and G₃ according to the gate signals VG₂ and VG₃; the secondary bidirectional switch circuits F₃ controls the electric connection between the scan lines G₃ and G₄ according to the gate signals VG₃ and VG₄; and so on.

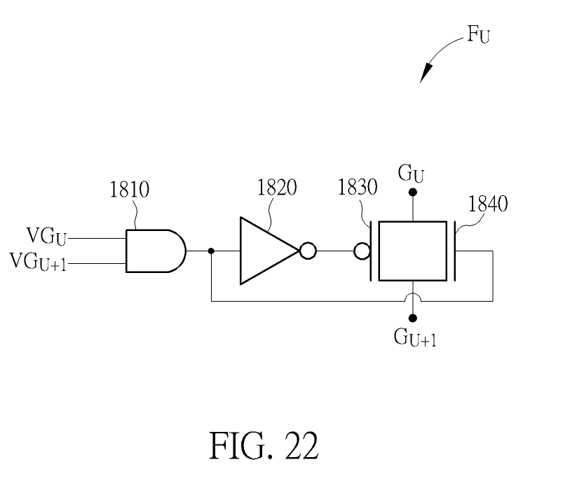

Please refer to FIG. 22 with reference of FIGS. 20 and 21. FIG. 22 is a circuit diagram of a secondary bidirectional switch circuit F_{U} in FIGS. 20 and 21. U is a positive integer, and 1≦U≦N−1. The secondary bidirectional switch circuit F_{U} comprises an AND gate 1810, an inverter 1820, a first switch 1830 and a second switch 1840. The AND gate 1810 has two input ends for receiving the gate signals VG_{U} and VG_{U+1} respectively from the shift registers SR_{U} and SR_{U+1}. The AND gate 1810 performs a logic AND operation on the two gate signals VG_{U} and VG_{U+1}. An input end of the inverter 1820 is coupled to an output end of the AND gate 1810. A first end of the first switch 1830 is coupled to the scan line G_{U}, a second end of the first switch 1830 is coupled to the scan line G_{U+1}, and a control end of the first switch 1830 is coupled to the output end of the inverter 1820. A first end of the second switch 1840 is coupled to the first end of the first switch 1830, a second end of the second switch 1840 is coupled to the second end of the first switch 1830 and the scan line G_{U+1}, and a control end of the second switch 1840 is coupled to the output end of the AND gate 1810. Therefore, when the gate signals VG_{U} and VG_{U+1} are at the high voltage level, the first switch 1830 and the second switch 1840 are turned on, such that the scan line G_{U} is electrically connected to the scan line G_{U+1} . When the gate signals VG_{U} and VG_{U+1} are not both at the high voltage level, the first switch 1830 and the second switch 1840 are turned off, such that the scan line G_{U} is electrically disconnected from the scan line G_{U+1}. In other words, the U^{th} secondary bidirectional switch circuit F_{U} of the secondary bidirectional switch circuits F₁ to F_{N-1} controls the electric connection between the U^{th} scan line G_{U} and the U+1^{th} scan line G_{U+1} of the scan lines G₁ to G_{N} according to the gate signals VG_{U} and VG_{U+1} output from the U+2^{th} shift resister SR_{U} and the U+3^{th} shift resister SR_{U+1}.

In the first gate driver 1320C, due to the even-numbered secondary bidirectional switch circuits F₂, F₄, . . . and F_{N-2}, the gate signals VG₁, VG₃, . . . and VG_{N-1} generated by the first gate driver 1320C may compensate the gate signals VG₂, VG₄, . . . and VG_{N-2}. Similarly, due to the odd-numbered secondary bidirectional switch circuits F₁, F₃, . . . and F_{N-1} of the second gate driver 1330C, the gate signals VG₂, VG₄, . . . and VG_{N} generated by the second gate driver 1330C may compensate the gate signals VG₁, VG₃, . . . and VG_{N-1}. Therefore, the signals at the ends of the scan lines G₁ to G_{N-1} may be strengthened through the secondary bidirectional switch circuits F₁ to F_{N-1}, such that the image quality of the LCD may be ensured.

According to the embodiments of the present invention, with the help of primary bidirectional switch circuits, the LCD may control electrical connections of the common voltage lines according to timing of polarity inversion of each row of pixel. Accordingly, electric charge of each common voltage line may be shared to other common voltage lines, and an equivalent capacitance of pixels driven by the common voltage buffers may be not too great. Since the equivalent capacitance of pixels driven by the common voltage buffers may be not too great, the layout area of the common voltage buffers may be reduced to contribute to the achievement of the narrow bezel design of the display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD), comprising:
a pixel matrix, comprising:
a plurality of pixels, arranged in a plurality of rows;
a plurality of scan lines, each of the scan lines being coupled to pixels arranged in one of the rows; and
a plurality of common voltage lines, each of the common voltage lines being coupled to the pixels arranged in one of the rows;
a plurality of shift registers, coupled to the scan lines and configured to sequentially output gate signals to the scan lines;
a plurality of common voltage generators, coupled between the shift registers and the common voltage lines and configured to output initial common voltages according to the gate signals; and
a plurality of primary bidirectional switch circuits, coupled to the shift registers and the common voltage lines, wherein each of the primary bidirectional switch circuits is configured to control electrical connection between two of the common voltage lines according to at least one of the gate signals output from the shift registers.

2. The liquid crystal display of claim 1, wherein the pixels are arranged in N rows, the shift registers comprise N+2 first shift registers, and the primary bidirectional switch circuits comprise N first primary bidirectional switch circuits, wherein a T^{th} one of the first primary bidirectional switch circuits is configured to control electrical connection between a T^{th} one and T+2^{th} one of the common voltage lines according to two gate signals output from a T^{th} one and T+1^{th} one of the first shift registers, N is an integer greater than 1, T is an integer, and 1≦T≦N.

3. The liquid crystal display of claim 2, wherein a first one and a second one of the first shift registers are dummy first shift registers.

4. The liquid crystal display of claim 2, wherein the shift registers further comprise N+2 second shift registers, and the primary bidirectional switch circuits further comprise N second primary bidirectional switch circuits, wherein a T^{th} one of the second primary bidirectional switch circuits is configured to control electrical connection between a T^{th} one and T+2^{th} one of the common voltage lines according to two gate signals output from a T^{th} one and T+1^{th} one of the second shift registers, N is an integer greater than 1, T is an integer, and 1≦T≦N.

5. The liquid crystal display of claim 4, wherein a first one and a second one of the second shift registers are dummy first shift registers.

6. The liquid crystal display of claim 4, wherein the N+2 first shift registers and the N first primary bidirectional switch circuits are integrated in a first gate driver of the liquid crystal display, the N+2 second shift registers and the N second primary bidirectional switch circuits are integrated in a second gate driver of the liquid crystal display, and the first gate driver and the second gate driver are positioned at two sides of the liquid crystal display.

7. The liquid crystal display of claim 2, wherein odd-numbered primary bidirectional switch circuits of the primary bidirectional switch circuits are integrated in a first gate driver of the liquid crystal display, even-numbered primary bidirectional switch circuits of the primary bidirectional switch circuits are integrated in a second gate driver of the liquid crystal display, and the first gate driver and the second gate driver are positioned at two sides of the liquid crystal display.

8. The liquid crystal display of claim 1, wherein each of the primary bidirectional switch circuits is configured to control the electrical connection between two of the common voltage lines according to two of the gate signals output from two of the shift registers.

9. The liquid crystal display of claim 8, wherein each of the primary bidirectional switch circuits comprises:
a NOR gate, having two input ends configured to receive the two gate signals output from the two shift registers;
an inverter, having an input end coupled to an output end of the NOR gate;
a first switch, a first end of the first switch being coupled to one of the two common voltage lines, a second end of the first switch being coupled to another of the two common voltage lines, and a control end of the first switch being coupled to an output end of the inverter; and
a second switch, a first end of the second switch being coupled to the first end of the first switch, a second end of the second switch being coupled to the second end of the first switch, and a control end of the second switch being coupled to the output end of the NOR gate.

10. The liquid crystal display of claim 1 further comprising a plurality of secondary bidirectional switch circuits coupled to the scan lines, wherein each of the secondary bidirectional switch circuits is configured to control electrical connection between two of the scan lines according to two of the gate signals output from two neighboring shift registers of the shift registers.

11. The liquid crystal display of claim 10, wherein the pixels are arranged in N rows, a number of the secondary bidirectional switch circuits is equal to N−1, wherein a U^{th} one of the second primary bidirectional switch circuits is configured to control electrical connection between a U^{th} one and U+1^{th} one of the scan lines according to two gate signals output from a U+2^{th} one and U+3^{th} one of the shift registers, N is an integer greater than 1, U is an integer, and 1≦U≦N−1.

12. The liquid crystal display of claim 11, wherein even-numbered secondary bidirectional switch circuits of the secondary bidirectional switch circuits are integrated in a first gate driver of the liquid crystal display, odd-numbered secondary bidirectional switch circuits of the secondary bidirectional switch circuits are integrated in a second gate driver of the liquid crystal display, and the first gate driver and the second gate driver are positioned at two sides of the liquid crystal display.

13. The liquid crystal display of claim 10, wherein each of the secondary bidirectional switch circuits comprises:
an AND gate, having two input ends configured to receive the two gate signals output from the two neighboring shift registers;
an inverter, having an input end coupled to an output end of the AND gate;
a first switch, a first end of the first switch being coupled to one of the two scan lines, a second end of the first switch being coupled to another of the two scan lines, and a control end of the first switch being coupled to an output end of the inverter; and
a second switch, a first end of the second switch being coupled to the first end of the first switch, a second end of the second switch being coupled to the second end of the first switch, and a control end of the second switch being coupled to the output end of the AND gate.

14. The liquid crystal display of claim 1 further comprising a plurality of common voltage buffers, coupled between the common voltage generators and the common voltage lines, and configured to buffer the initial common voltages so as to output a plurality of common voltages to the common voltage lines.

15. The liquid crystal display of claim 1, wherein each of the primary bidirectional switch circuits is configured to control the electrical connection between two of the common voltage lines according a gate signal output from a single one of the shift registers.

16. The liquid crystal display of claim 8, wherein each of the primary bidirectional switch circuits comprises:
an inverter, having an input end for receiving the gate signal output from the single one of the shift registers;
a first switch, a first end of the first switch being coupled to one of the two common voltage lines, a second end of the first switch being coupled to another of the two common voltage lines, and a control end of the first switch receiving the gate signal output from the single one of the shift registers; and
a second switch, a first end of the second switch being coupled to the first end of the first switch, a second end of the second switch being coupled to the second end of the first switch, and a control end of the second switch being coupled to an output end of the inverter.
